(19) United States
(12) Patent Application Publication
(10) Pub. No.: US 2008/0077407 A1
(43) Pub. Date: Mar. 27, 2008

(54) PHONETICALLY ENRICHED LABELING IN UNIT SELECTION SPEECH SYNTHESIS

(75) Inventors: Mark Beutnagel, Mendham, NJ (US); Alistair Conkie, Morristown, NJ (US); Yeon-Jun Kim, Whippany, NJ (US); Ann K. Syrdal, Morristown, NJ (US)

Correspondence Address: AT&T CORP., ROOM 2A207, ONE AT&T WAY, BEDMINSTER, NJ, 07921, US

(73) Assignee: AT&T Corp., New York, NY (US)

(21) Appl. No.: 11/535,146

(22) Filed: Sep. 26, 2006

(51) Int. Cl. G10L 13/00

(52) U.S. Cl. 704/261

(57) ABSTRACT

A system, method and computer-readable media are disclosed for improving speech synthesis. A text-to-speech (TTS) voice database for use in a TTS system is generated by a method comprising labeling a voice database phonemically and applying a pre-/post-vocalic distinction to the phonemic labels to generate a TTS voice database. When a system synthesizes speech using speech units from the TTS voice database, the database provides phonemes for selection using the pre-/post-vocalic distinctions which improve unit selection to render the synthetic speech more natural.

### BACKGROUND OF THE INVENTION

1. Field of the Invention

The present invention relates to speech processing and more specifically to manipulating phonetic labels in a voice database to improve speech synthesis.

2. Introduction

The present application relates to speech processing and speech synthesis. Unit selection based synthesis has brought huge improvement in text-to-speech (TTS) synthesis quality and is widely used in many applications. To generate the desired utterance, previous synthesizers generally parameterized and regenerated speech with signal modification that reduces the quality of synthesized speech. On the other hand, unit selection based synthesizers choose suitable fragments from a database of speech recorded from a speaker and join them together with minimal signal modifications. Unit selection based synthesizers using minimal modification of the speech signal produce highly intelligible and natural sounding utterances instead of buzzy or robotic sounding speech.

Minimal modification in unit selection based synthesis does not only bring high synthesis quality, but also causes some problems. Some of the problems with unit selection synthesis weren't problems in the earlier TTS systems because they used signal modification. So, for example, plosive closure and burst durations were modified to suit the context. In addition, listeners who experience highly quality synthesis speech by the unit selection based systems are not forgiving. Therefore, such listeners perceive and are more critical of even minor mistakes.

Often problems are caused by the discrepancy between phones asked for by a TTS front-end and phones selected from a labeled voice database. We usually label speech databases with phonemic symbols rather than phonetic ones. However, the same phoneme can be realized in different forms (allophones) depending on certain phone contexts. The phoneme /t/ in American English, for example, generates several allophones.

One possible approach to alleviate the problem is to specify greater allophonic detail in TTS front-end and database labels. The present inventors have tried to reduce such discrepancies by introducing allophones in the phone set. We differentiated one of the most variable phonemes, /t/, with three allophones: normal (with stop closure and burst) [t], flapped [dx], glottalized [q]. We updated letter-to-sound rules to predict such allophones in the certain phone context and re-labeled voice databases with the detailed phone set. See Yeon-Jun Kim, Ann K. Syrdal, and Matthias Jilka, “Improving TTS by Higher Agreement between Predicted versus Observed Pronunciations,” in Proceeding of the 5^{th} ISCA ITRW on Speech Synthesis, 2004, incorporated herein by reference.

Synthesis quality was improved by that technique, however some other mismatches still remained unresolved. Selection of inappropriate consonant variants resulted in various phenomena. For example, unreleased /p/ chosen for /p/ in “PIN number” sometimes sounded like “bin number”. In another case when the phone sequence /t cy t/ in “eight eight” is chosen for “Tate”, the initial /t/ sound is missing, making it sound like “ate” instead of “Tate”. Therefore, what is needed in the art is further improvements to the selection of the appropriate phones from a labeled voice database to provide higher quality speech synthesis.

### SUMMARY OF THE INVENTION

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

To address the problem in the state of the art, the inventors propose a new phone labeling method that creates better matches with phone realization in speech, which is a new technique to solve the phone variant problem in the current unit selection based TTS synthesis. The new phone set includes the distinction of consonant variants dependent on their position in the syllable structure, pre-vocalic and post-vocalic, which reduces missing consonants and consonant confusion.

Embodiments of the invention include systems methods and computer readable medium storing instructions for controlling a computing device. the method embodiment comprises labeling a voice database phonemically and applying a pre-/post-vocalic distinction to the phonemic labels such that when the TTS synthesis system selects phonemes, the modified labeled phonemes that are selected provide impaired speech synthesis.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 shows an exemplary system embodiment;

FIGS. 2A, 2B illustrates spectograms for a reference TTS system and the proposed TTS system.

FIG. 3 illustrates a difference between the reference TTS system and the new TTS system according to an aspect of the invention; and

FIG. 4 illustrates a method embodiment.

### DETAILED DESCRIPTION OF THE INVENTION

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

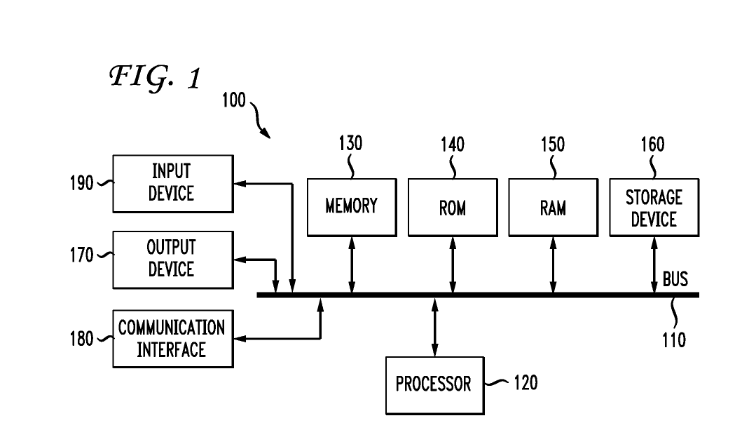

First we discuss a basic system embodiment. With reference to FIG. 1, an exemplary system for implementing the invention includes a general-purpose computing device 100, including a processing unit (CPU) 120 and a system bus 110 that couples various system components including the system memory such as read only memory (ROM) 140 and random access memory (RAM) 150 to the processing unit 120. Other system memory 130 may be available for use as well. It can be appreciated that the invention may operate on a computing device with more than one CPU 120 or on a group or cluster of computing devices networked together to provide greater processing capability. The system bus 110 may be any of several types of bus structures including a memory bus or memory controller, a peripheral bus, and a local bus using any of a variety of bus architectures. A basic input/output (BIOS), containing the basic routine that helps to transfer information between elements within the computing device 100, such as during start-up, is typically stored in ROM 140. The computing device 100 further includes storage means such as a hard disk drive 160, a magnetic disk drive, an optical disk drive, tape drive or the like. The storage device 160 is connected to the system bus 110 by a drive interface. The drives and the associated computer readable media provide nonvolatile storage of computer readable instructions, data structures, program modules and other data for the computing device 100. The basic components are known to those of skill in the art and appropriate variations are contemplated depending on the type of device, such as whether the device is a small, handheld computing device, a desktop computer, or a computer server.

Although the exemplary environment described herein employs the hard disk, it should be appreciated by those skilled in the art that other types of computer readable media which can store data that are accessible by a computer, such as magnetic cassettes, flash memory cards, digital versatile disks, cartridges, random access memories (RAMs), read only memory (ROM), a cable or wireless signal containing a bit stream and the like, may also be used in the exemplary operating environment.

To enable user interaction with the computing device 100, an input device 190 represents any number of input mechanisms, such as a microphone for speech, a touch-sensitive screen for gesture or graphical input, keyboard, mouse, motion input, speech and so forth. The input may be used by the presenter to indicate the beginning of a speech search query. The device output 170 can also be one or more of a number of output means. In some instances, multimodal systems enable a user to provide multiple types of input to communicate with the computing device 100. The communications interface 180 generally governs and manages the user input and system output. There is no restriction on the invention operating on any particular hardware arrangement and therefore the basic features here may easily be substituted for improved hardware or firmware arrangements as they are developed.

We now turn to more details associated with the invention. Unit selection techniques have improved the quality of text-to-speech (TTS) synthesis. However, mistakes which had been less noticeable previously in poorer quality synthetic speech become very noticeable in more natural-sounding synthetic speech. Many problems appear to be caused by mismatches between phones requested by the TTS front-end and phones selected from the labeled speech inventory. Given the input text and the added information predicted by the TTS front-end, finding the optimal units from a speech inventory database still remains a challenge in unit selection TTS synthesis.

Consonants affect intelligibility of speech synthesis and they are realized differently depending on their position in the syllable. Pre-vocalic plosives must have a release burst before the vowel begins while post-vocalic consonants may or may not be released. When a post-vocalic consonant is chosen to synthesize a pre-vocalic consonant, it may cause problems such as missing consonants, consonant confusion or word-boundary confusion.

The inventors propose a new phone labeling method which differentiates pre-vocalic and post-vocalic consonants. The proposed phone labeling method leads unit selection to choose contextually accurate phone units and minimizes unit selection errors caused by lack of specification in TTS front-end transcriptions and phone labels in the speech inventory. In a listening test the TTS voices labeled with the pre-vocalic/post-vocalic distinction were rated significantly higher (+0.33) compared to reference voices that did not use this distinction.

Finding the optimal units from a speech inventory database is important to synthesize high quality speech in a unit selection TTS system. However, it is not an easy problem because there are mismatches between the unit (phoneme) sequences called for by the TTS front-end and units (phone) labeled in the actual speech inventory. Those discrepancies started from the trivial fact that the TTS front-end is mainly written in grapheme-to-phoneme mapping rules rather than phone mapping. Before discussing phonetic variations of a phoneme, it is noted that a phoneme is not a single sound, but a group of sounds. Phonemes represent abstract units that form the basis for writing down a language systematically and unambiguously.

There are several approaches to bridge the gap between phoneme and phone. For example, CART based methods and a method using a dictionary of alternate pronunciations. See M. D. Riley and A. Ljojle, “Automatic generation of detailed pronunciation lexicons,” in Automatic Speech and Speaker Recognition, chapter 12, Kluwer Academic Publishers, 1995, and Wael Hamza, Ellen Eide, and Raimo Bakis, “Reconciling pronunciation differences between the front-end and the back-end in the ibm speech synthesis system,” in INTERSPEECH 2004, 2004, incorporated herein by reference. In the previous work of the invention introduced above, we applied phoneme-to-phone mapping (allophone specification) rules were applied to the /t/ sound which was frequently chosen inaccurately by unit selection.

Flapping Rule:
When an alveolar stop consonant like /t/ or /d/ is between two vowels, the second of which is unstressed, it becomes a voiced tap [dx]. For example, the /t/s in “pretty [p r ih dx iy]”, “data [d ey dx ax]” may be replaced by a [dx].

Glottalization Rule:

When a voiceless alveolar stop locates before an alveolar nasal in the same syllable, it becomes a glottal stop. For example, the /t/ before syllabic [n] as in “button” may be replaced by a glottal stop [q].

Even though there are phenomena as shown above, it is still difficult to make a complete phoneme-to-phone mapping rule set because of uncertainty. For example, a word, “suit” in the TIMIT corpus was found in four different phonetic realizations, [s uw tcl t], [s uw tcl], [s uw dx], [s uw q]. See W. Fisher, V. Zue, D. Bernstein and D. Pallet, “An Acoustic-Phonetic Database,” J. Acoust. Soc. Am., Vol. 81, 1986, incorporated herein by reference.

Phonetic variations of a consonant or a syllable may be caused not only by surrounding phonetic context, but also by the position in the syllable. A syllable is generally composed of onset and rhyme. Any consonant or consonant cluster before the vowel forms the onset and the rhyme consists of a vowel and any consonant or cluster after the vowel.

The consonants before and after a vowel are often realized differently depending on their position in the syllable. For example, pre-vocalic stop consonants must have a burst part before the vowel begins while post-vocalic stop consonants may or may not have a burst part. For example, /d/ in “dark” has both the closure [dcl] and the burst [d] while /k/ after the vowel has only the closure [kcl]. Therefore, it may cause problems in speech synthesis, such as a dropout, consonant confusion or word boundary confusion when a post-vocalic consonant segment is chosen to synthesize a pre-vocalic consonant.

Selection of stop consonants a factor in intelligibility of unit selection based TTS synthesis. To avoid this problem, the penalties have been given to the units which violate syllable boundaries and word boundaries when the unit selection algorithm computes the target cost and the join cost of those units. However, it still occasionally chooses inappropriate units and makes conspicuous mistakes in synthesizing speech. Therefore, the inventors introduce the pre-/post-vocalic distinction which prevents consonants in the rhyme from being used to synthesize onsets, and vice versa.

TABLE 1
Transcriptions using the pre-/post-vocalic distinction

| Word | Phonetic (TIMIT) | Proposed |
|---|---|---|
| club | kcl k l ah bcl b | k l ah b_{—} |
| | kcl l ah bcl | |
| group | gcl g r uw pcl p | g r uw p_{—} |
| | gcl g r uw pcl | |
| handbag | hh ae n dcl b ae gcl g | hh ae n_{—} d_{—} b ae g_{—} |
| | hh ae n dcl b ae gcl | |
| best | bcl b eh s tcl t | b eh s_{—} t_{—} |
| | bcl b eh s tcl | |
| | bcl b eh s q | |
| dark | dcl d aa r kcl k | d aa r_{—} k_{—} |
| | dcl d aa r kcl | |
| | dcl d aa kcl k | |
| full | f uh l | f uh l_{—} |
| | f el | |
| more | m ao r | m ao r_{—} |
| | m ao ax | |
| | m ao er | |
| | m ao | |

The proposed phone labeling method distinguishes pre-vocalic and post-vocalic consonants. New phone symbols for the post-vocalic consonants are introduced while the phone symbols of pre-vocalic consonants are the same as the existing phone symbols. For example, the post-vocalic consonant are labeled by adding an underscore (‘_’) like as /b_, d_, g_/. In addition to stop consonants, more distinctions are introduce to transcribe dark /l, r/s with /l_, r_/ and syllable final nasals with /m_, n_/. As shown in Table 1, each post-vocalic consonant covers various phonetic transcriptions by itself. While the symbol ‘_’ is preferred, it is appreciated that any symbol or symbols may be used to label.

Examples of an extended phone set which includes pre-/post-vocalic consonants are shown in Tables 2 and 3.

TABLE 2
pre-vocalic consonants.

| SYMBOL | EXAMPLE WORD | TRANSCRIPTION |
|---|---|---|
| b | bee | b iy |
| d | day | d ey |
| g | gay | g ey |
| p | pea | p iy |
| t | tea | t iy |
| k | key | k iy |
| jh | joke | j ow k_{—} |
| ch | choke | ch ow k_{—} |
| s | sea | s iy |
| sh | she | sh iy |
| z | zone | z ow n_{—} |
| zh | azure | ae zh er |
| f | fin | f ih n_{—} |
| th | thin | th ih n_{—} |
| v | van | v ae n_{—} |
| dh | then | dh eh n_{—} |
| m | mom | m aa m_{—} |
| n | noon | n uw n_{—} |
| l | lay | l ey |

TABLE 3
post-vocalic consonants.

| SYMBOL | EXAMPLE WORD | TRANSCRIPTION |
|---|---|---|
| b_{—} | bob | b aa b_{—} |
| d_{—} | dad | d ae d_{—} |
| g_{—} | gag | g ae g_{—} |
| p_{—} | pop | p aa p_{—} |
| t_{—} | cat | k ae t_{—} |
| k_{—} | cock | k aa k_{—} |
| jh_{—} | change | ch ey n_{—} jh_{—} |
| ch_{—} | watch | w aa ch_{—} |
| s_{—} | source | s ao r_{—} s_{—} |
| sh_{—} | bush | b uh sh_{—} |
| z_{—} | noze | n ow z_{—} |
| zh_{—} | beige | b ey zh_{—} |
| f_{—} | cliff | k l ih f_{—} |
| th_{—} | bath | b ae th_{—} |
| v_{—} | cave | k ey v_{—} |
| dh_{—} | bathe | b ey dh_{—} |
| m_{—} | ham | hh ae m_{—} |
| n_{—} | son | s ah n_{—} |
| l_{—} | hall | hh ao l_{—} |
| r_{—} | car | k aa r_{—} |

The voice database in the new TTS system is first labeled phonemically instead of allophonic variations. Then the pre-/post-vocalic distinction is applied to phonemic labels according to syllable boundary information given by the TTS front-end. The configuration of the TTS system is also changed according to the proposed phone set extension. In the new TTS system, the pre-/post-vocalic distinction module replaced the allophone mapping module used in the previous configuration. Instead of applying allophone mapping rules to the phoneme sequence predicted by the TTS front-end, the new TTS system assigns pre-/post-vocalic consonant symbols using the given syllable boundary information. The proposed distinctions embedded in the speech inventory also feed more suitable segments to the search algorithm of unit selection.

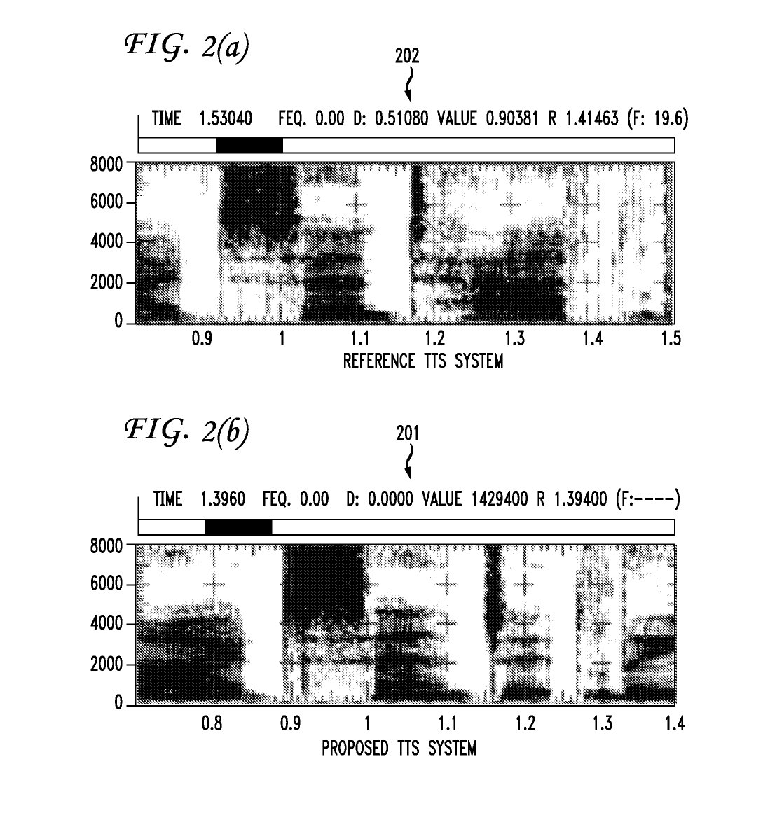

FIG. 2A is a spectrogram 202 that illustrates a type of common word-boundary confusion, for example in synthesis of “sent at” by the reference TTS system. The confusion is caused by selection of a word-initial (pre-vocalic) aspirated /t/ (taken from a recording of “. . . women to . . . ” in the voice database and used instead in a word-final context. The resulting synthesized utterance sounds like “sen tat” instead of the intended “sent at”. In contrast, the spectrogram 204 shown in FIG. 2B illustrates the proper selection of an unaspirated syllable-final (post-vocalic) /t/ (taken from the context “ . . . agreement at . . .” in the recorded voice database). This version of “sent at”, synthesized by the new phonetically enriched TTS system, causes no word boundary confusion to listeners.

A listening test was conducted to evaluate whether the pre-/post-vocalic distinction leads to a measurable improvement in synthesis quality. The listening test was designed to compare two voices (female and male) and two TTS systems (the reference TTS version and the TTS version with phonetically enrichment), each used to synthesize 15 sentences (6 interactive prompts and 9 sentences from on-line news articles).

All 60 test stimuli were energy normalized to −20 dBov. Test files were renamed through symbolic links to prevent identification of test conditions. Listening tests were interactive and web-based. Listeners rated each test sentence on a 5-point scale from 1 (Bad) to 5 (Excellent). Listeners were 21 adults from the AT&T research community; 14 were native speakers of English, 7 were fluent non-native speakers of English.

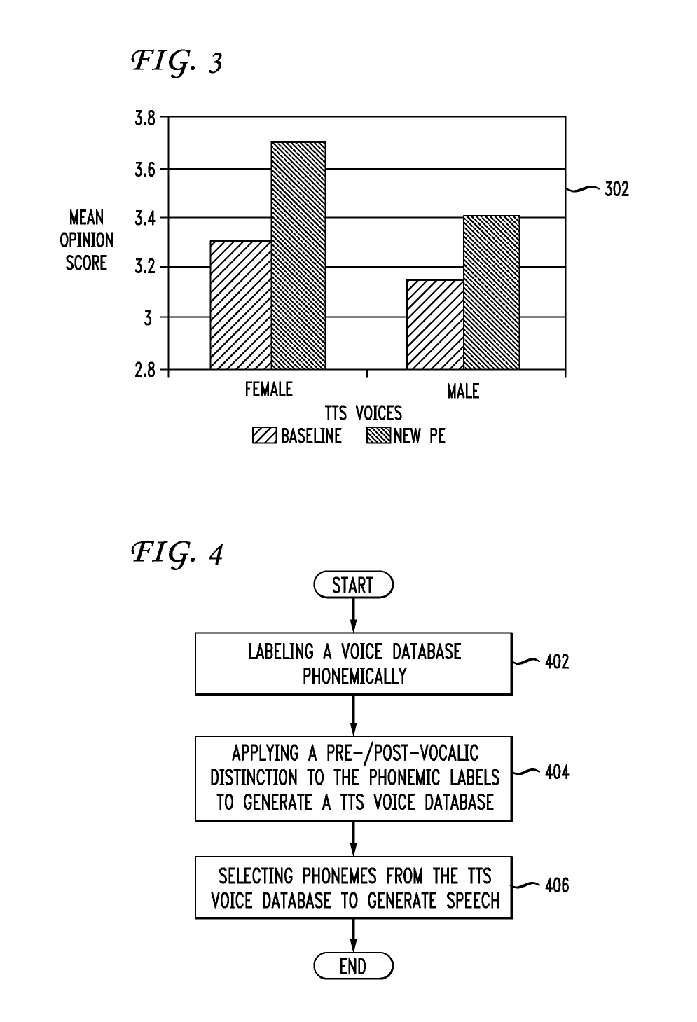

In the subjective rating test, the voices with the new phone set extension were rated significantly higher than the previous ones, 0.4 mean opinion score (MOS) improvement in the female voice and 0.26 MOS improvement in the male voice as shown in the graph 302 of FIG. 3. A repeated measures analysis of variance (ANOVA) was performed on the ratings data. ANOVA design consists of Voice+System+Sentence+Voice*System+Voice*Sentence+System*Sentence+Voice*System*Sentence.

All three main effects were statistically significant. The female voice (MOS=3.505) was rated significantly (p<0.001) higher than the male voice (MOS=3.276). (Voice: F(1,20)=15.115p<0.001) The phonetically enriched TTS version (MOS=3.556) was rated 0.330 MOS higher than the existing version (MOS=3.225), and that difference was highly significant (p<0.0001). (System: F(1,20)=61.516, p<0.0001) There were also significant differences in ratings among test sentences. (Sentence: F(14,280)=20.381, p<0.0001)

Three of the four interactions were significant, but the most interesting interaction for our purposes, Voice*System, did not reach statistical significance (F(1,20)=3.454, p<0.078). This indicates that the effect of improvements by the new phone set extension was statistically equivalent for both voices tested.

Listening test result indicated that the proposed pre-/post-vocalic distinctive labeling improves synthesis quality of the test sentences. Several of the sentences synthesized by the reference TTS system have clear mistakes, but even in the other sentences which don't have evident mistakes it was observed that the proposed system is generally superior to the reference system.

Preserving the syllable structure by the pre-/post-vocalic distinction could lead to smoother joins in unit concatenation, not only avoiding selection of inappropriate synthesis units. Even though the synthesis unit as used in our system is not limited to syllables or demi-syllables, the pre-/post-vocalic distinction eventually limited consonants in the rhyme (coda) not to be used for initial consonant (onset) synthesis. It could make it possible to have both flexibility and robustness in the unit selection based TTS synthesis.

FIG. 4 illustrates an example method embodiment of the invention. As shown, the method comprises labeling a voice database phonemically (402), applying a pre-/post-vocalic distinction to the phonemic labels to generate a TTS voice database (404), and selecting phonemes from the TTS voice database to synthesis speech (406).

In summary, a new phonetically enriched labeling method that differentiates pre-vocalic and post-vocalic consonants is proposed. The proposed method contributed significant improvement of synthesis quality in the unit selection based TTS system.

The proposed phone labeling method led unit selection to choose contextually accurate phone segments and minimized unit selection errors caused either by discrepancies between TTS front-end transcriptions and phone labels in the speech inventory or by lack of specificity in phoneme labels.

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the invention may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof through a communications network. In a distributed computing environment, program modules may be located in both local and remote memory storage devices.

Although the above description may contain specific details, they should not be construed as limiting the claims in any way. Other configurations of the described embodiments of the invention are part of the scope of this invention. For example, another embodiment may comprise a synthesized speech signal generated from the methods disclosed herein. An author or animated entity such as a human or animal may also utilize a synthesized speech signal as disclosed herein. Further there is clearly no restriction on languages and although English was discussed here, the principles of the invention may apply to any language. Accordingly, the appended claims and their legal equivalents should only define the invention, rather than any specific examples given.

I claim:

1. A text-to-speech (TTS) voice database for use in a TTS system, the TTS voice database generated by a method comprising:
labeling a voice database phonemically; and
applying a pre-/post-vocalic distinction to the phonemic labels to generate a TTS voice database, wherein the TTS voice database provides phonemics for selection by a TTS system to generate speech.

2. The TTS voice database of claim 1, wherein applying the pre-/post-vocalic distinction is applied according to syllable boundary information.

3. The TTS voice database of claim 2, wherein the syllable boundary information is provided by a TTS front-end.

4. A text-to-speech (TTS) system comprising:
a module configured to distinguish between pre-vocalic and post-vocalic consonants;
a module configured to perform unit selection based at least in part on the pre-/post-vocalic consonants; and
a module configured to generate speech using the selected units.

5. The TTS system of claim 4, wherein unit selection occurs from an inventory of units having associated pre-/post-vocalic consonant distinctions.

6. The TTS system of claim 4, wherein unit selection, penalties are applied to units that violate syllable boundaries and/or word boundaries when a unit selection algorithm computes costs.

7. The TTS system of claim 6, wherein the costs are at least the target cost and join cost.

8. The TTS system of claim 4, wherein a voice database comprises added phone symbols for post-vocalic consonants.

9. The TTS system of claim 8, wherein in the voice database the phone symbols for pre-vocalic consonants do not have added phone symbols.

10. The TTS system of claim 9, wherein in the voice database, the added phone symbols are applied to dark and syllable final nasals.

11. A method of performing text-to-speech (TTS) systems, the method comprising:
receiving text;
assigning pre-/post-vocalic consonant symbols to the received text;
selecting units of speech from an inventory of speech units utilizing the pre-/post-vocalic consonant symbols; and
synthesizing speech with the selected units.

12. The method of claim 11, wherein assigning pre-/post-vocalic consonant symbols is performed using boundary information.

13. The method of claim 11, wherein the inventory of speech units includes embedded pre-/post-vocalic distinctions.
